(19) United States
(12) Patent Application Publication
(10) Pub. No.: US 2007/0085386 A1
(43) Pub. Date: Apr. 19, 2007

(54) Subassembly, especially automotive body structure comprising a roof module and a roof frame portion

(76) Inventors: Thomas Zirbs, Weil der Stadt (DE); Thomas Zitterbart, Dietenheim (DE)

Correspondence Address: STEPHAN A. PENDORF, P.A., PENDORF & CUTLIFF, 5111 MEMORIAL HIGHWAY, TAMPA, FL, 33634, US

(21) Appl. No.: 10/555,133

(22) PCT Filed: Mar. 20, 2004
(86) PCT No.: PCT/EP04/02959

§ 371 Date: Nov. 6, 2006

(30) Foreign Application Priority Data
Apr. 30, 2003 (DE) 103 19 442.8

(51) Int. Cl. B62D 25/06; B60J 7/043

(52) U.S. Cl. 296/218; 296/216.01; 296/210

(57) ABSTRACT

The subassembly (10) comprises a frame structure (12) and a frame module (14) which in turn comprises a frame structure portion (16). Provision is made here for the frame structure portion (16) to be joined at least partially to the frame structure (12) by means of a bearing contact which promotes alignment of an associated region (38) of the frame structure (12) into an intended assembly position.

### CROSS REFERENCE TO RELATED APPLICATION

This application is a national stage of PCT/EP2004/002959 filed Mar. 20, 2004 and based upon DE 103 19 442.8 filed Apr. 30, 2003 under the International Convention.

### BACKGROUND OF THE INVENTION

1. Field of the invention

The invention relates to a subassembly comprising a frame structure and a frame module which in turn comprises a frame structure portion. The invention further relates to a corresponding frame module and to a corresponding frame structure.

2. Related Art of the invention

A subassembly of the initially mentioned type and in particular a corresponding automotive body comprising a body module in the form of a roof module and comprising a body structure are known. For example, DE 199 19 505 A1 discloses a vehicle roof with a roof opening between two vehicle-fixed lateral longitudinal members to which a preassembled roof module covering the roof opening can be securely attached. The roof module comprises a front or rear vehicle roof crossmember which is used to join the two longitudinal members and thus to strengthen the vehicle roof transversely. To assemble the roof module, the latter can be pushed into the longitudinal members from the front or rear of the vehicle and fastened to said members by means of an adhesive joint.

### SUMMARY OF THE INVENTION

It is an object of the invention to provide a subassembly of the initially mentioned type which is characterized by a correct attachment of the module to the frame structure. It is a further object of the invention to provide a corresponding frame module and a corresponding frame structure.

The subassembly according to the invention is distinguished by the fact that the frame structure portion is joined at least partially to the frame structure by means of a bearing contact which promotes alignment of an associated region of the frame structure into an intended assembly position. As a result, during assembly of the frame module on the frame structure, an automatically induced aligning movement of an associated region of said frame structure is thus brought about and it is consequently made possible for a correct assembly position to be assumed by these regions and the frame module relative to the frame structure.

The bearing contact is advantageously designed to be positively locking. The positively locking bearing contact here serves to dimensionally stabilize at least part of the connection region between the frame module and the frame structure, it being possible at the same time to achieve optimized transfer of force from the frame module into the frame structure when the frame module is subjected to force, for example as a result of a collision.

According to one possible embodiment, the subassembly may be an automotive body, the frame module may be a body module and the frame structure portion may be a body frame portion. Furthermore, the body frame portion may for example be a roof frame portion which is joined at least partially to the body structure in a pillar region by means of a positively locking bearing contact. Since the pillar regions of an automotive body are among the most highly loaded subregions of a vehicle roof during a collision, the positively locking bearing contact between the roof frame portion of the roof module and the body structure is formed in a pillar region, so that the greatest possible proportion of the forces introduced into the roof module during a collision can be transferred into the corresponding body pillar by means of the positively locking bearing contact, in order to ensure that the roof structure of the automotive body is sufficiently positionally stable.

According to one possible embodiment, the roof frame portion is a front roof crossmember which can be connected to the upper edge of a vehicle front window and is joined to the body structure in the A-pillar region at least partially by positive locking. Alternatively, the roof frame portion may also be a rear roof crossmember which can be connected to the upper edge of a vehicle rear window and is joined to the body structure in the C-pillar region at least partially by positive locking. Such roof modules may already be equipped with a roof liner, it being possible for the roof liner, in particular in the region of the roof frame portion, already to be provided with the intended add-on parts. The roof module therefore preferably comprises a painted roof panel, if appropriate a roof opening system and also a roof liner with add-on parts. Of course, the roof module may also be formed as a glass roof module with suitable functional units.

The body frame portion is advantageously additionally fixed by means of a nonpositively locking and/or a material-binding fastening system. The nonpositively locking fastening system may for example be a screwed connection, whereas the material-binding fastening system is preferably in the form of an adhesive joint. The body module can be fixed to the body structure even in regions outside of the body frame portion by means of at least one corresponding or other suitable fastening system. In the case of a roof module, the latter may be fastened to the associated pillar (A-pillar or C-pillar).

The positively locking bearing contact is preferably formed in the region of the production system. Since the fastening system is used to fix the body module to the body structure and is thus intended to ensure the desired transfer of force between these functional units, the arrangement of the positively locking bearing contact in the region of the fastening system is expedient because the positively locking bearing contact ensures a transfer of force, in particular from the body module into the body structure, which is particularly favorable with regard to the deformation of the automotive body.

The positively locking bearing contact may be formed on an affixed shaped part and a deformed sheet-metal portion or on two deformed sheet-metal portions or on two affixed shaped parts. Where there are manufacturing restrictions relating to achievable sheet-metal geometries for the positively locking bearing contact, use may thus be made of separate shaped parts which may be affixed to corresponding structural units (body modules or body structures). As a result, the positively locking bearing contact may be created by means of various, mutually complementary shape geometries on suitable shaped parts, with one shaped part being able to be joined to the roof module and the other shaped part to the body structure, for example by means of a welded joint.

According to a preferred embodiment, the positively locking bearing contact is formed at least in certain regions by a conical seat. A conical seat is characterized by a relatively large bearing contact face and, when the bearing contact has been produced, simultaneously has a self-centering action during the positioning phase of the body module relative to the body structure. The conical seat here can be designed to be dimensionally stable in a relatively simple manner, whereby correct and favorable transfer of force between the body module and the body structure can be achieved even when these connection regions are subjected to relatively large forces. Furthermore, a positively locking bearing contact can be formed between the structural parts to be connected by a spherical bearing face making contact with a conical bearing face or by a conical bearing face making contact with a cylindrical bearing face or else by means of suitable shape combinations of different configuration.

In a development of the invention, the positively locking bearing contact is formed on curved aligning faces which are complementary to one another. Accordingly, the functional units to be joined are spatially aligned with one another during production of the bearing contact between the body module and the body structure, it being possible in particular for side walls of the body structure which may not be in the ideal position to be automatically aligned on account of the relatively great dimensional stability of the body module, which now has an integrated body frame portion. This is particularly important because a body frame portion is now integrated in the body module, so that there is a high probability that movable lateral regions of the body structure are not in an exact predetermined assembly position prior to the start of assembly. Apart from producing a stable connection of the body module to the body structure in a connection region, the positively locking bearing contact may now additionally be used to align the body structure, or regions thereof, to ensure sufficiently accurate dimensional and/or positional tolerances of the automotive body. For this purpose, provision is preferably made for the curvature of the aligning faces to have an orientation which, during production of the bearing contact, promotes an aligning movement of an associated region of the body structure into an intended assembly position. Preferably, the curvature of the aligning face of the body module is designed to be convex, whereas the curvature of the aligning face of the associated region of the body structure may, in a complementary manner, be made to have a concave shape.

According to a preferred variant embodiment, during production of the positively locking connection, only subregions of the curved aligning faces are in bearing contact with one another. During production of the positively locking connection between the aligning faces, the curved faces thus roll or slide on one another until the aligning faces are in bearing contact with one another in subregions, the position of the subregions depending on the respective aligning movement of the associated region of the body structure during assembly of the body module on the body structure.

The body module is advantageously additionally fastened to the body structure by means of an adhesive joint. Thus, the possible method of fastening the body module to the body structure is not restricted by the production of a positively locking bearing contact but instead is facilitated in view of a correct adhesive joint, since correct positioning of the units to be joined, in particular in the connection region, is ensured as a result of the aligning effect. In the case of a roof module, an adhesive joint may be provided in the associated pillar region and/or at further body edges.

Further advantages of the invention will emerge from the description.

### BRIEF DESCRIPTION OF THE DRAWINGS

The invention will be explained in more detail with the aid of a number of preferred exemplary embodiments with reference to a schematic drawing, in which:

FIG. 1 shows a schematic side view of part of an automotive body according to the invention during assembly of the roof module;

FIG. 2 shows a schematic plan view of the automotive body of FIG. 1 after assembly of the roof module has been completed;

FIG. 3 shows a schematic partial sectional representation of a fastening region between a roof module and a body structure after production of a positively locking bearing contact according to a first embodiment;

FIG. 4 shows a corresponding partial sectional representation of the fastening region of FIG. 3 according to a second, alternative embodiment;

FIG. 5 shows a schematic perspective representation of a fastening region of a body structure according to a third, alternative embodiment;

FIG. 6 shows a schematic perspective representation of a fastening region of a roof module belonging to the body structure of FIG. 5;

FIG. 7 shows a schematic longitudinal sectional representation of the fastening region of an automotive body according to the invention having a body structure and having a roof module, according to a fourth, alternative embodiment;

FIG. 8 shows a schematic cross-sectional representation of the fastening region of FIG. 7;

FIG. 9 shows a schematic plan view of the fastening region of FIGS. 7 and 8;

FIG. 10 shows a schematic cross-sectional representation in the longitudinal direction X of a fastening region according to a fifth, alternative embodiment;

FIG. 11 shows a schematic cross-sectional representation in the transverse direction Y of the fastening region, along the section line XI-XI of FIG. 10;

FIG. 12 shows a schematic plan view of the fastening region of FIG. 10;

FIG. 13 shows a schematic cross-sectional representation of a fastening region according to a sixth, alternative embodiment;

FIG. 14 shows a schematic plan view of the fastening region of FIG. 13;

FIG. 15 shows a schematic plan view of a fastening region according to a seventh, alternative embodiment;

FIG. 16 shows a schematic cross-sectional representation of a fastening region according to a seventh, alternative embodiment;

FIG. 17 shows a schematic cross-sectional representation of a fastening region according to an eighth, alternative embodiment, and

FIG. 18 shows a schematic cross-sectional representation of a fastening region according to a ninth, alternative embodiment.

### DETAILED DESCRIPTION OF THE INVENTION

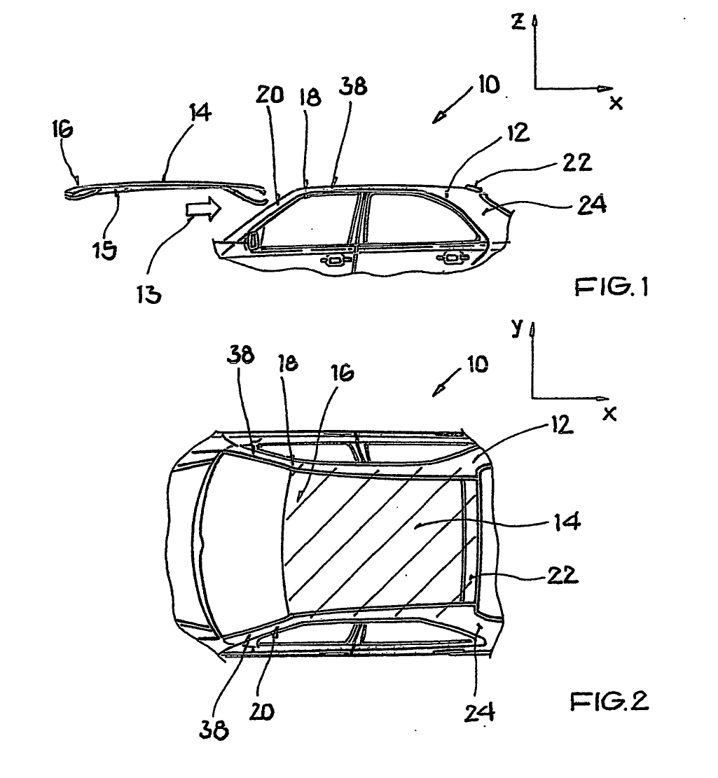

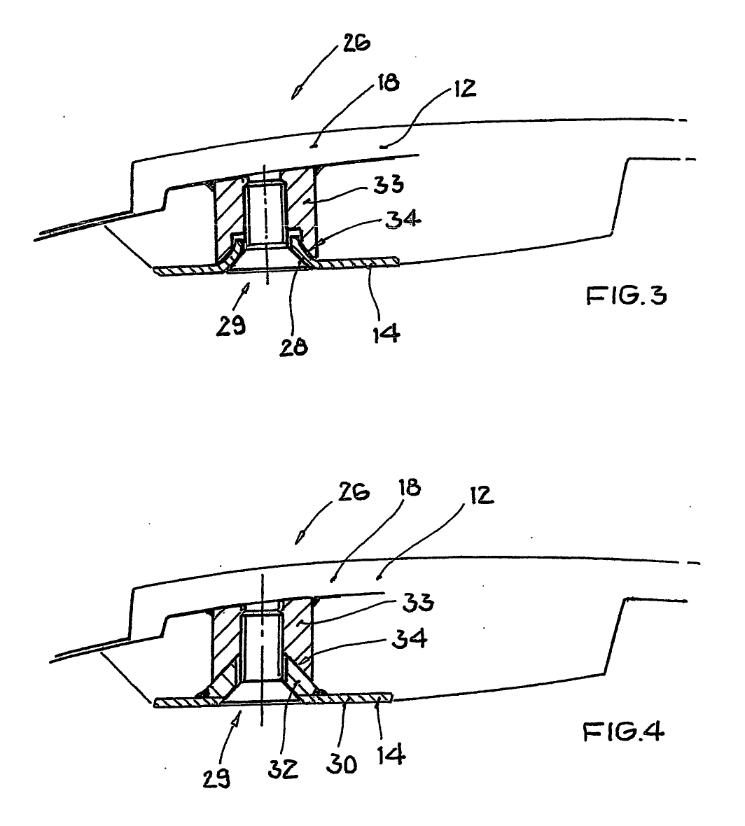

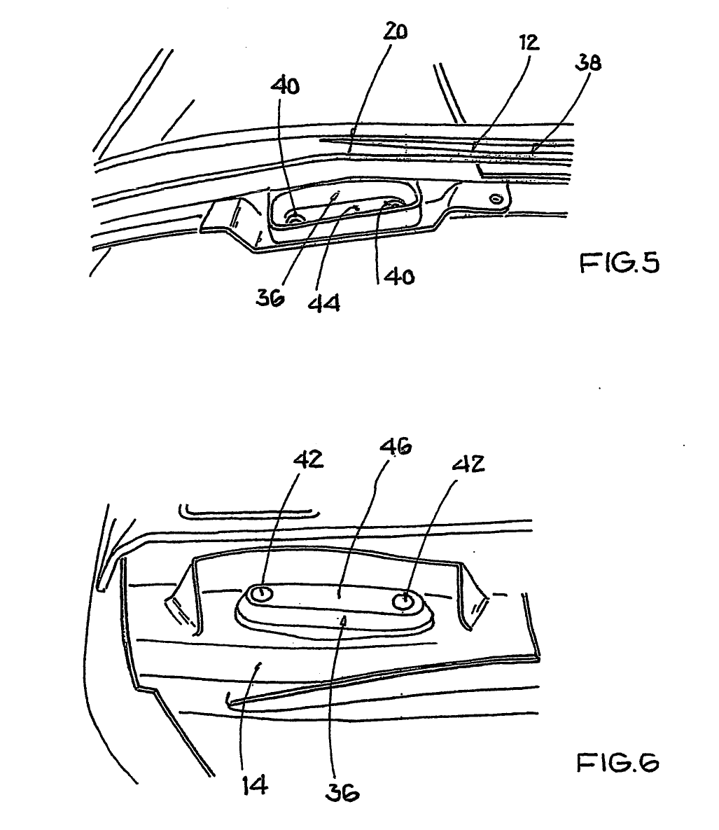

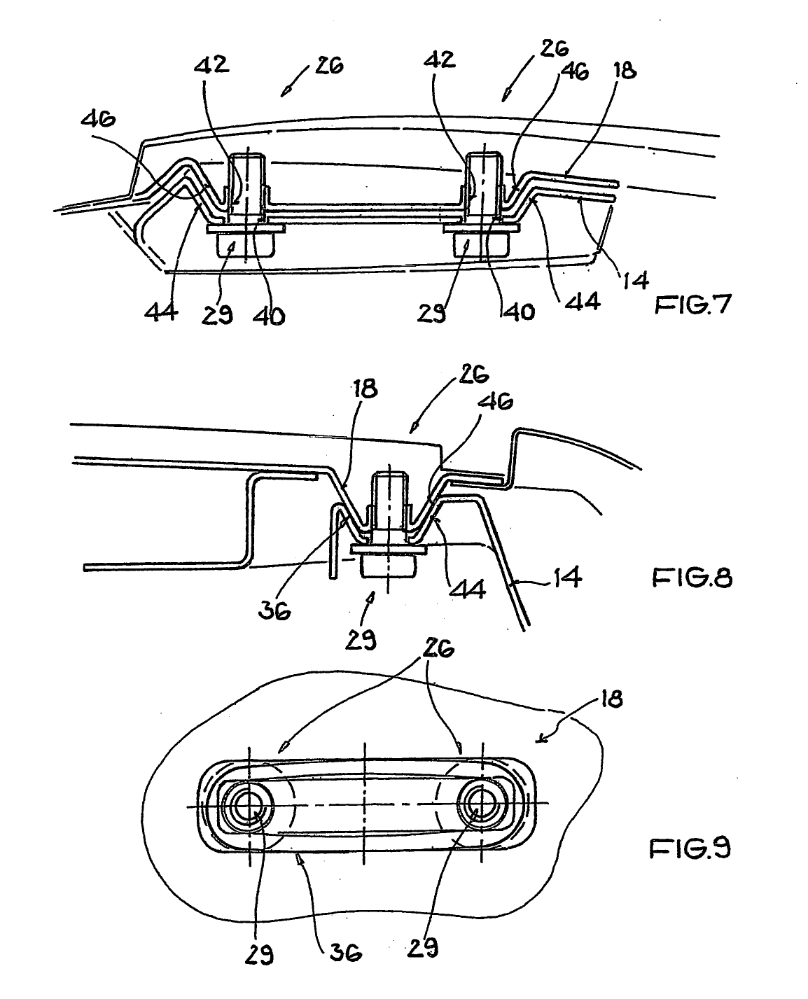

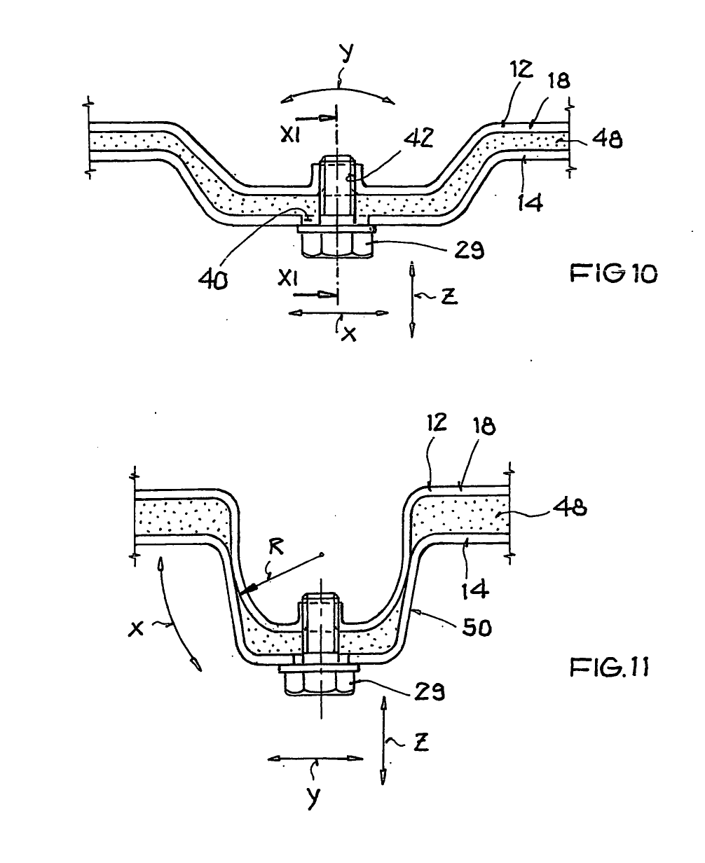

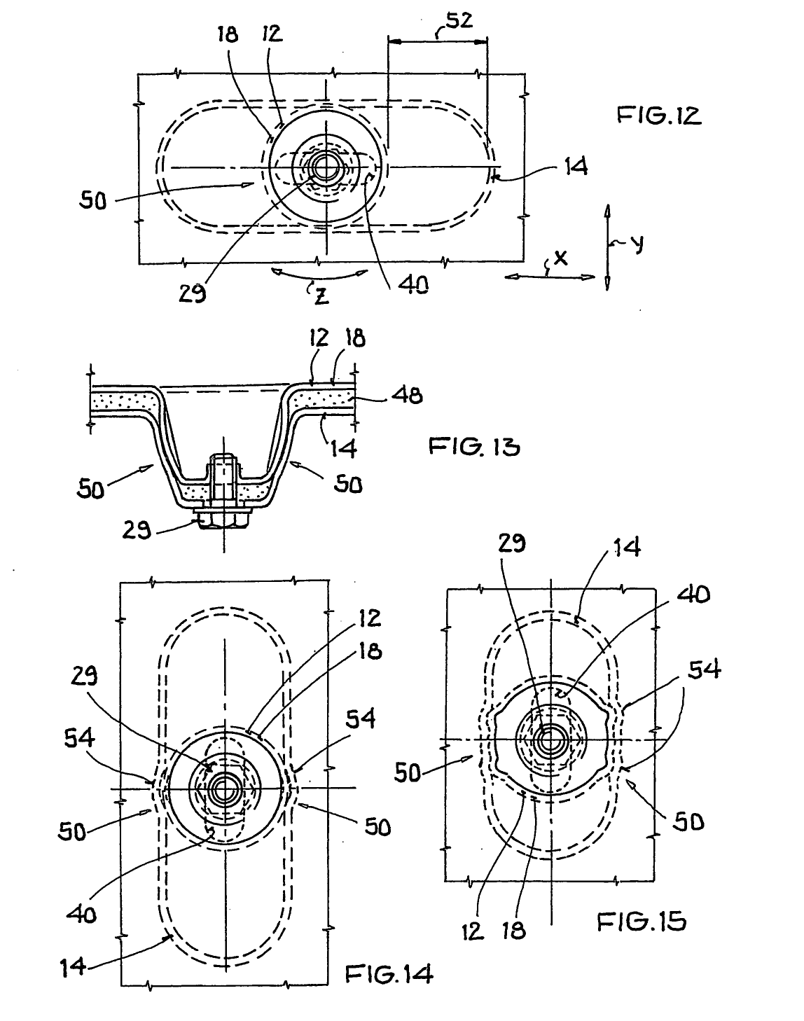

FIGS. 1 and 2 are schematic views showing a subassembly 10 in the form of an automotive body which comprises a body structure 12 and a roof module 14. According to FIG. 1, the roof module 14 is moved in the direction of arrow 13 toward the body structure 12 so as to be fastened thereon in a defined assembly position as shown in FIG. 2. The roof module 14 is provided with a roof frame portion 16 in the form of a front roof crossmember which can be connected to the upper edge of a vehicle front window. The roof frame portion 16 is joined to the body structure 12 in corresponding A-pillar regions 20 thereof. In this arrangement, the body structure 12 comprises a rear roof crossmember 22 and a C-pillar region 24 on each body side wall 38. The roof module 14 is equipped with a roof liner 15 and thus constitutes a completely preassembled structural unit. The roof frame portion 16 of the roof module 14 is joined to the body structure 12 in a pillar region 18 (in the A-pillar region 20 in the present exemplary embodiment), thereby forming a positively locking bearing contact. According to an alternative embodiment which has not been represented, it is also possible for such a positively locking bearing contact to be provided in the region of the rear roof crossmember 22 for the purpose of joining the latter to the C-pillar region 24 of the body structure 12.

FIGS. 3 and 4 show possible exemplary embodiments of a positively locking bearing contact between the roof module 14 and the body structure 12 in a pillar region 18, and in particular in the A-pillar region 20. In both exemplary embodiments, the roof module 14 is fixed to the body structure 12 in the pillar region 18 by means of a nonpositively locking fastening system 26 in the form of a screwed connection. In this arrangement, the positively locking bearing contact is formed in the region of the fastening system 26. According to FIG. 3, the positively locking bearing contact may be formed between a deformed sheet-metal portion 28 of the roof module 14 and a shaped part 33, the shaped part 33 being fastened to the body structure 12 in the pillar region 18 by means of a welded joint. The exemplary embodiment according to FIG. 4 shows a positively locking bearing contact between two shaped parts 32, 33, the shaped part 33 being welded to the body structure 12 and the shaped part 32 being fastened to a metal sheet 30 of the roof module 14 by means of a welded joint. In both exemplary embodiments according to FIGS. 3 and 4, the positively locking bearing contact is formed by means of a conical seat 34. The conical seat 34 allows improved transfer of force between the roof module 14 and the body structure 12, is characterized by increased dimensional stability and moreover has a centering action during the assembly operation of the roof module 14, whereby the roof module 14 can automatically assume a defined predetermined assembly position relative to the body structure 12 during the assembly operation. In addition to the nonpositively locking screwed connection of the fastening system 26, there may, if appropriate, be provided a material-binding connection between the roof module 14 and the body structure 12, for example by means of an adhesive joint, in the pillar region 18.

FIGS. 5 and 6 show a third, alternative exemplary embodiment of a positively locking bearing contact, which is to be formed in the A-pillar region 20, between the body structure 12 (FIG. 5) and the roof module 14 (FIG. 6). The body structure 12 comprises a locating seat 44, in which an aligning element 46 of the roof module 14 can be accommodated in a positively locking manner. The locating seat 44 comprises two mutually opposite aligning faces 36 which are curved concavely. Correspondingly, the aligning element 46 also comprises two aligning faces 36 which are curved convexly outward in a complementary manner to the locating contour of the locating seat 44. The locating seat 44 is provided with two through openings 40, while the aligning element 46 comprises correspondingly arranged threaded openings 42. The through openings 40 and the threaded openings 42 are used to produce a screwed connection between the roof module 14 and the body structure 12 after the aligning element 46 of the roof module 14 has been accommodated in the locating seat 44 of the body structure 12. In this case, an aligning movement of the roof module 14 and/or of an associated body side wall 38 of the body structure 12 into a correspondingly intended predetermined assembly position takes place during production of the bearing contact between the aligning faces 36 of the locating seat 44 and of the aligning element 46 by virtue of the curvature of the aligning faces 36. The aligning element 46 thus has the function of a joining wedge. Given suitable orientations of curvature of the aligning faces 36 of the locating seat 44 and of the aligning element 46, it is also possible for only subregions of the curved aligning faces 36 to be in bearing contact with one another during production of the positively locking connection, these subregions also being able to change with respect to their position and size during the assembly operation of the roof module 14.

FIGS. 7, 8 and 9 are different views showing a fastening region with positively locking bearing contact of a roof module 14 joined to a body structure 12, substantially according to the exemplary embodiment of FIGS. 5 and 6. The variant of FIGS. 7 to 9 differs from the exemplary embodiment of FIGS. 5 and 6 in that, in order to produce a positively locking bearing contact, the roof module 14 is now provided with an associated locating seat 44 and two through openings 40, whereas the body structure 12 in the intended pillar region 18 comprises a correspondingly formed aligning element 46 with two threaded openings 42. This thus represents a reversal of the locating principle of the exemplary embodiment of FIGS. 5 and 6, but otherwise the same aligning effects are achieved by means of the positively locking bearing contact of the aligning faces 36. It can be seen from the plan view of the fastening region of the assembled roof module 14 shown in FIG. 9 that the curved aligning faces 36 have only a subregion in bearing contact with one another.

The positively locking bearing contact in the connection region between the roof module 14 and the body structure 12 in the pillar region 18 enables the body side walls 38 to be drawn in the transverse direction (Y direction of FIG. 2) to the desired dimension, while the roof module 14 is at the same time fixed in terms of its vertical position with respect to the body structure 12 (Z direction of FIG. 1). In this case, displacement of the roof module 14 in the longitudinal direction (X direction of FIGS. 1 and 2) of the body structure 12 and twisting of the roof module 14 about a Z axis are allowed. Securing the roof module 14 in the X direction and/or about an axis of rotation (Z axis) is problematic, since even a small positional difference in the body side walls 38 relative to one another would cause twisting of the entire roof module 14. This would result in wide positional tolerances of the roof module 14 being caused in the rear roof region.

The curvatures, formed as joining bevels, of the aligning faces 36 may be configured in the A-pillar region 20 for example in such a way that they permit about ±3.5 mm tolerance in the formation of the positively locking bearing contact, since the corresponding body side wall 38 is drawn automatically to zero dimension again by means of the positively locking bearing contact.

The threaded openings 42 can be produced in a deep-drawn part, for example by means of the “Flowdrill process”. Alternatively, the threaded openings 42 may also be provided in the form of punched-in nuts, welded-in nuts, clipped-in nuts, blind rivet nuts or glued-in shaped nuts.

The roof module 14 is additionally fastened to the body structure 12, preferably by means of an adhesive joint, in the pillar region 18 and/or at further body edges. In this arrangement, screwed connections are distinguished by the possibility of particularly rapid load absorption, by contrast with adhesive joints in which a minimum drying time has to elapse with regard to load absorption, which constitutes a restriction in terms of the assembly operation. A combination of adhesive joints and screwed connections provides an advantageous effect in this respect, since the clamping forces of a screwed connection promote the formation of a correct adhesive joint.

FIGS. 10 to 12 are various views showing a possible configuration of a fastening region according to a fifth, alternative embodiment. Here, an adhesive layer 48 is additionally provided in the region of the screwed connection 29 in the pillar region 18 between the body structure 12 and the roof module 14. In a bearing contact region 50 the body structure 12 has a spherical or aligning face of radius R, whereas the roof module 14 is of conical design in this region 50. During the assembly of the roof module 14, elastic and/or plastic deformations may occur in the bearing contact region 50 on the structural parts involved. The roof module 14 additionally comprises a through opening 40 in the form of an oblong hole (see, in particular, FIGS. 10 and 12) which serves to ensure that there is a degree of freedom in the X direction (longitudinal direction) during the assembly of the roof module 14, whereas the roof module 14 is secured in the Y direction (transverse direction) with regard to its positioning relative to the body structure 12 (see FIG. 11). Thus, when one of the structural parts involved (roof module 14 or body structure 12) is loaded in the X direction, an absorption of force first takes place in the intended bearing contact region 50 (deformation region), it being possible in the event of excessive loading (for example a collision) for there to be a further relative displacement of the structural parts with respect to one another, for example by the length dimension according to double arrow 52 in FIG. 12, with the existing adhesive force (adhesive layer 48) being overcome in the process. When the roof module 14 is in such an end position relative to the body structure 12, there is a positively locking connection which extends peripherally through about 180°, the acting reaction force on the screw or screws being relatively small, with the result that relatively high loads can be withstood by means of such a fastening system.

A positively locking connection in the bearing contact region 50 between the roof module 14 and the body structure 12 may be obtained relatively simply by means of an elastic and/or plastic deformation of at least one of the structural parts involved. In the exemplary embodiment according to FIGS. 13 and 14, the material of the roof module 14 (lower part) is softer than that of the body structure 12 (upper part). In the bearing contact regions 50 (deformation regions) the lower part can thus be initially deformed elastically and, if appropriate, additionally plastically. In the exemplary embodiment represented, the upper part comprises a respective bead 54 in the bearing contact regions 50, with the result that, during assembly of the lower part, a correspondingly associated bead 54 is also formed into the lower part. This makes it possible to achieve reinforcement of the upper part and additionally plastic deformation of the lower part. The deformation should be as large as possible with a relatively small application of force. Relatively high loading forces can be transferred or absorbed in principle by means of plastically deformed connection elements. According to the exemplary embodiment of FIG. 15, it is also possible for more than one bead 54, namely for example two beads 54, to be formed as a negative in a bearing contact region 50 when placing the upper part in the lower part.

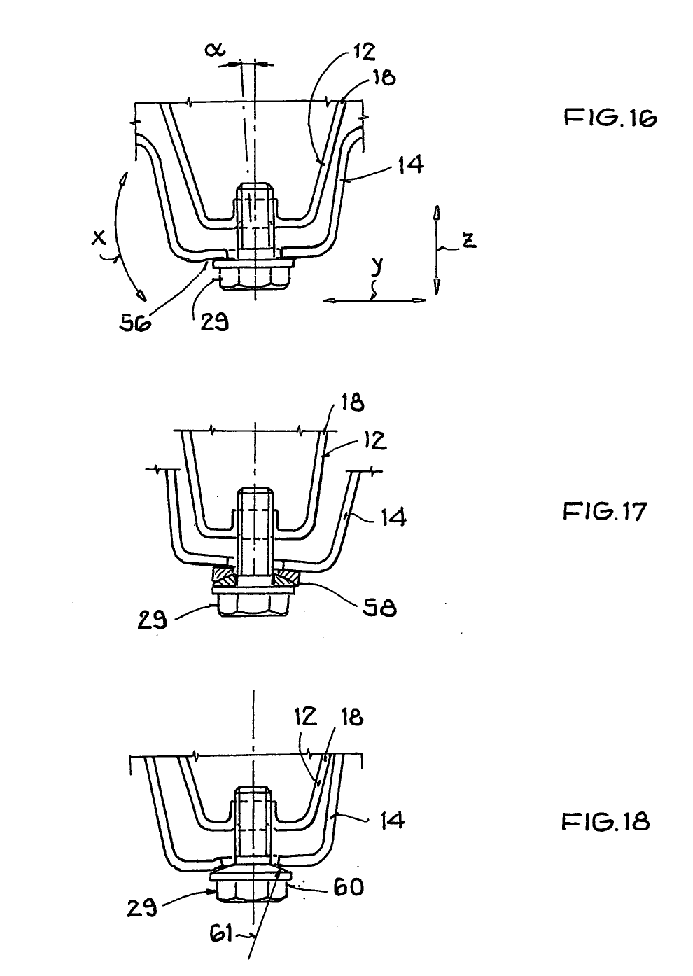

FIG. 16 shows an alternative variant of a fastening system, according to which an elastic and/or plastic deformation of the roof module 14 is obtained in the fastening region represented with the formation of an angular offset of the fastening system through an angle a in the X direction of rotation relative to the body structure 12 outside of the fastening region. As a result, a desired degree of freedom in the X direction of rotation is obtained by means of the deformation.

FIG. 17 represents a screwed connection 29 employing a ball socket 58, making possible an angular position of the fastening screw relative to the roof module 14 without there having to occur an associated deformation of said roof module 14. By contrast, FIG. 18 shows a screwed connection 29 comprising a screw 60 which has a spherical head bearing face 61 relative to the roof module 14 (lower part). The head bearing face 61 may, if appropriate, be pressed into the lower part 14 so as to form an elastic and/or plastic deformation which is restricted locally to the fastening region of said lower part 14. The exemplary embodiments represented in FIGS. 17 and 18 thus also serve to create a desired degree of freedom about a corresponding axis (X axis or Y axis).

It is thus possible to assemble the roof module 14 (frame module) on the body structure 12 (frame structure) while ensuring up to five degrees of freedom (three axes of rotation and two axes of movement) and in combination with only a single fixed degree of freedom (Y axis; spacing of the side parts of the vehicle). This means that production tolerances which occur can be compensated relatively simply, since positionally accurate positioning of the roof module 14 relative to the body structure 12 is possible during the roof module assembly while achieving particularly high gap dimension accuracy. By virtue of the fixed degree of freedom in the Y direction, it is also possible to align the body side walls 38, which are still “free” prior to the roof module assembly, with the dimension in the Y direction predetermined by the body frame portion 16 of the roof module 14. The wedge action of the aligning faces 36 makes it possible for relatively small joining forces to produce comparatively large aligning forces in the Y direction. It is also possible by means of a roof module 14 (frame module) assembled in such a way for an additional adhesive joint to be fixed between the structural parts to be joined until the adhesive cures, with the result that further fixing elements can be dispensed with. If appropriate, the now secure connection between the structural parts mentioned may eliminate the need for a relatively laborious operation of adhesively bonding the roof module (frame module) all around onto the body structure 12 (frame structure). The adhesive joint may, if appropriate, also be used to form an additional positively locking connection between the structural parts to be joined.

The joining concept described is not restricted to the example of the automotive body construction but may also be advantageously used in other areas, including those outside of automotive construction. In principle, fundamental reversals (for example with regard to the configuration of the upper part and the lower part) of the exemplary embodiments represented are also conceivable within the scope of the invention.

1. A subassembly (10) comprising a frame structure (12) and a frame module (14) which in turn comprises a frame structure portion (16), wherein the frame structure portion (16) is joined at least partially to the frame structure (12) by means of a bearing contact which promotes alignment of an associated region (38) of the frame structure (12) into an intended assembly position.

2. The subassembly as claimed in claim 1, wherein the bearing contact is designed to be positively locking.

3. The subassembly as claimed in claim 1, wherein the subassembly (10) is an automotive body, the frame module (14) is a body module, the frame structure portion (16) is a body frame portion and the frame structure (12) is a body structure.

4. An automotive body as claimed in claim 3, wherein the body frame portion (16) is a roof frame portion which is joined at least partially to the body structure (12) in a pillar region (18) by means of a positively locking bearing contact.

5. The automotive body as claimed in claim 4, wherein the roof frame portion (16) is a front roof crossmember which can be connected to the upper edge of a vehicle front window and is joined to the body structure (12) in the A-pillar region (20) at least partially by positive locking.

6. The automotive body as claimed in claim 4, wherein the roof frame portion (16) is a rear roof crossmember (22) which can be connected to the upper edge of a vehicle rear window and is joined to the body structure (12) in the C-pillar region (24) at least partially by positive locking.

7. The automotive body as claimed in claim 4, wherein the body frame portion (16) is additionally fixed to the body structure (12) by means of a nonpositively locking and/or a material-binding fastening system (26).

8. The automotive body as claimed in claim 7, wherein the fastening system (26) is a screwed connection.

9. The automotive body as claimed in claim 7, wherein the positively locking bearing contact is formed in the region of the fastening system (26).

10. The automotive body as claimed in claim 4, wherein the positively locking bearing contact is formed on an affixed shaped part (33) and a deformed sheet-metal portion (28).

11. The automotive body as claimed in claim 4, wherein the positively locking bearing contact is formed on two affixed shaped parts (32, 33) or on two deformed shaped parts.

12. The automotive body as claimed in claim 4, wherein the positively locking bearing contact is formed at least in certain regions by a conical seat (34).

13. The automotive body as claimed in claim 4, wherein the positively locking bearing contact is formed on curved aligning faces (36) which are complementary to one another.

14. The automotive body as claimed in claim 13, wherein the curvature of the aligning faces (36) has an orientation which, during production of the bearing contact, promotes an aligning movement of an associated region (38) of the body structure (12) into an intended assembly position.

15. The automotive body as claimed in claim 14, wherein, during production of the positively locking connection, only subregions of the curved aligning faces (36) are in bearing contact with one another.

16. The automotive body as claimed in claim 4 wherein the body module (14) is additionally fastened to the body structure (12) by means of an adhesive joint.

17. A frame module (14) for fastening to a frame structure (12) so as to form the subassembly (10) comprising a frame structure (12) and a frame module (14) which in turn comprises a frame structure portion (16), wherein the frame structure portion (16) is joined at least partially to the frame structure (12) by means of a bearing contact which promotes alignment of an associated region (38) of the frame structure (12) into an intended assembly position.

18. A frame structure (12) for fastening a frame module (14), in particular a body module or roof module, so as to form the subassembly (10), in particular the automotive body, comprising a frame structure (12) and a frame module (14) which in turn comprises a frame structure portion (16), wherein the frame structure portion (16) is joined at least partially to the frame structure (12) by means of a bearing contact which promotes alignment of an associated region (38) of the frame structure (12) into an intended assembly position.

19. A frame structure as in claim 18, wherein said frame structure (12) is a body structure.

20. A frame module as in claim 17, wherein said framemodule (14) is a body module or roof module.
